(19) United States
(12) Patent Application Publication
(10) Pub. No.: US 2016/0217529 A1
(43) Pub. Date: Jul. 28, 2016

(54) IDENTIFYING BIDDING STRATEGIES FOR CONTENT PROVIDERS IN ONLINE AUCTIONS

(71) Applicant: Google Inc., Mountain View, CA (US)

(72) Inventors: Patrick Hummel, Cupertino, CA (US); Kay H. Brodersen, Zurich (CH); Jan-Moritz Peter Franosch, Adliswil (CH)

(21) Appl. No.: 14/992,416

(22) Filed: Jan. 11, 2016

(30) Foreign Application Priority Data
Jan. 28, 2015 (DE) 102015001072.7

(51) Int. Cl. G06Q 40/04; G06Q 30/08

(52) U.S. Cl. CPC G06Q 40/04; G06Q 30/08

(57) ABSTRACT

Systems and methods for determining bid adjustments that may result in lower costs and/or increased benefit to content providers, and providing recommendations for adjusting a bidding strategy accordingly, are disclosed. One method includes determining a first marginal cost associated with a first set of one or more of a plurality of auctions for presentation of content items within one or more resources. The marginal costs represents a cost to a content provider associated with an additional action performed in association with the content items presented within the resources. The method further includes determining a second marginal cost associated with a second set of one or more of the plurality of auctions. The method further includes determining whether a difference between the first marginal cost and the second marginal cost exceeds a threshold, and generating a recommendation to adjust a bidding strategy in response to determining the difference exceeds the threshold.

### CROSS REFERENCE TO RELATED APPLICATIONS

The present application claims priority to and the benefit of German Patent Application No. 102015001072.7, filed Jan. 28, 2015, titled “Identifying bidding strategies for content providers in online auctions,” which is incorporated herein by reference in its entirety.

### BACKGROUND

In a networked environment, such as the Internet or other networks, first-party content providers can provide information for public presentation on resources, for example webpages, documents, applications, and/or other resources. Additional third-party content can also be provided by third-party content providers for presentation on the client device together with the information from the first-party content providers. Third-party content providers may participate in a plurality of auctions for presenting their content on the resources. One challenge content providers face is determining a bidding strategy for bids to submit to the auctions.

### SUMMARY

One illustrative implementation of the disclosure relates to a method. The method includes determining a first marginal cost associated with a first set of one or more of a plurality of auctions for presentation of content items within one or more resources. The marginal cost represents a cost to a content provider associated with an additional action performed in association with the content items presented within the resources. The method further includes determining a second marginal cost associated with a second set of one or more of the plurality of auctions. The method further includes determining whether a difference between the first marginal cost and the second marginal cost exceeds a threshold. The method further includes generating a recommendation to adjust a bidding strategy in response to determining the difference exceeds the threshold.

Another implementation relates to a system including at least one computing device operably coupled to at least one memory and configured to determine a first marginal cost associated with a first set of one or more of a plurality of auctions for presentation of content items within one or more resources. The marginal cost represents a cost to a content provider associated with an additional action performed in association with the content items presented within the resources. The at least one computing device is further configured to determine a second marginal cost associated with a second set of one or more of the plurality of auctions. The at least one computing device is further configured to determine whether a difference between the first marginal cost and the second marginal cost exceeds a threshold. The at least one computing device is further configured to generate a recommendation to adjust a bidding strategy in response to determining the difference exceeds the threshold.

Another implementation relates to one or more computer-readable storage media having instructions stored thereon that, when executed by one or more processors, cause the one or more processors to perform operations including determining a first marginal cost associated with a first set of one or more of a plurality of auctions for presentation of content items within one or more resources. The marginal cost represents a cost to a content provider associated with an additional action performed in association with the content items presented within the resources. The operations further include determining a second marginal cost associated with a second set of one or more of the plurality of auctions. The operations further include determining whether a difference between the first marginal cost and the second marginal cost exceeds a threshold. The operations further include generating a recommendation to adjust a bidding strategy in response to determining the difference exceeds the threshold.

Another implementation relates to a method. The method includes determining a first marginal cost associated with a first set of one or more of a plurality of auctions for presentation of content items within one or more resources. The marginal cost represents a cost to a content provider associated with an additional action performed in association with the content items presented within the resources. The method further includes determining a second marginal cost associated with a second set of one or more of the plurality of auctions. The method further includes estimating a value to the content provider for the additional action based on at least one of the first marginal cost and the second marginal cost. The method further includes generating a recommended adjustment to one or more bids associated with one or both of the first set of auctions or the second set of auctions based on the estimated value to the content provider.

Another implementation relates to a system including at least one computing device operably coupled to at least one memory and configured to determine a first marginal cost associated with a first set of one or more of a plurality of auctions for presentation of content items within one or more resources. The marginal cost represents a cost to a content provider associated with an additional action performed in association with the content items presented within the resources. The at least one computing device is further configured to determine a second marginal cost associated with a second set of one or more of the plurality of auctions. The at least one computing device is further configured to estimate a value to the content provider for the additional action based on at least one of the first marginal cost and the second marginal cost. The at least one computing device is further configured to generate a recommended adjustment to one or more bids associated with one or both of the first set of auctions or the second set of auctions based on the estimated value to the content provider.

Another implementation relates to one or more computer-readable storage media having instructions stored thereon that, when executed by one or more processors, cause the one or more processors to perform operations including determining a first marginal cost associated with a first set of one or more of a plurality of auctions for presentation of content items within one or more resources. The marginal cost represents a cost to a content provider associated with an additional action performed in association with the content items presented within the resources. The operations further include determining a second marginal cost associated with a second set of one or more of the plurality of auctions. The operations further include estimating a value to the content provider for the additional action based on at least one of the first marginal cost and the second marginal cost. The operations further include generating a recommended adjustment to one or more bids associated with one or both of the first set of auctions or the second set of auctions based on the estimated value to the content provider.

Yet another implementation relates to a method. The method includes obtaining, by one or more processors, bid data associated with a plurality of types of auctions for presentation of content items within one or more resources. The method further includes calculating a marginal cost associated with each type of auction. The marginal cost represents a cost to a content provider associated with an additional action performed in association with the content items presented within the resources for the type of auction. The method further includes determining a current average cost per action performed in associated with the content items presented within the resources across the auctions under current bid amounts. The method further includes determining a first marginal cost within a range from a lowest marginal cost to a highest marginal cost among the calculated marginal costs for the plurality of types of auctions. The method further includes estimating first bid amounts in each of the types of auctions resulting in a marginal cost equal to the first marginal cost. The method further includes calculating a first average cost per action to the content provider across the auctions associated with the first bid amounts. The method further includes determining whether the first average cost per action is equal to or within a predetermined amount under the current average cost per action. The method further includes generating a recommendation to adjust the current bid amounts to the first bid amounts in response to determining the first average cost per action is equal to or within a predetermined amount under the current average cost per action. The method further includes adjusting the first marginal cost and repeating the estimating and calculating with the adjusted first marginal cost until the adjusted first marginal cost results in the first average cost per action being equal to or within the predetermined amount under the current average cost per action in response to determining the first average cost per action is above the current average cost per action or under the current average cost per action by more than the predetermined amount.

Another implementation relates to a system including at least one computing device operably coupled to at least one memory and configured to obtain bid data associated with a plurality of types of auctions for presentation of content items within one or more resources. The at least one computing device is further configured to calculate a marginal cost associated with each type of auction. The marginal cost represents a cost to a content provider associated with an additional action performed in association with the content items presented within the resources for the type of auction. The at least one computing device is further configured to determine a current average cost per action performed in associated with the content items presented within the resources across the auctions under current bid amounts. The at least one computing device is further configured to determine a first marginal cost within a range from a lowest marginal cost to a highest marginal cost among the calculated marginal costs for the plurality of types of auctions. The at least one computing device is further configured to estimate first bid amounts in each of the types of auctions resulting in a marginal cost equal to the first marginal cost. The at least one computing device is further configured to calculate a first average cost per action to the content provider across the auctions associated with the first bid amounts. The at least one computing device is further configured to determine whether the first average cost per action is equal to or within a predetermined amount under the current average cost per action. The at least one computing device is further configured to generate a recommendation to adjust the current bid amounts to the first bid amounts in response to determining the first average cost per action is equal to or within a predetermined amount under the current average cost per action. The at least one computing device is further configured to adjust the first marginal cost and repeating the estimating and calculating with the adjusted first marginal cost until the adjusted first marginal cost results in the first average cost per action being equal to or within the predetermined amount under the current average cost per action in response to determining the first average cost per action is above the current average cost per action or under the current average cost per action by more than the predetermined amount.

Another implementation relates to one or more computer-readable storage media having instructions stored thereon that, when executed by one or more processors, cause the one or more processors to perform operations including obtaining, by one or more processors, bid data associated with a plurality of types of auctions for presentation of content items within one or more resources. The operations further include calculating a marginal cost associated with each type of auction. The marginal cost represents a cost to a content provider associated with an additional action performed in association with the content items presented within the resources for the type of auction. The operations further include determining a current average cost per action performed in associated with the content items presented within the resources across the auctions under current bid amounts. The operations further include determining a first marginal cost within a range from a lowest marginal cost to a highest marginal cost among the calculated marginal costs for the plurality of types of auctions. The operations further include estimating first bid amounts in each of the types of auctions resulting in a marginal cost equal to the first marginal cost. The operations further include calculating a first average cost per action to the content provider across the auctions associated with the first bid amounts. The operations further include determining whether the first average cost per action is equal to or within a predetermined amount under the current average cost per action. The operations further include generating a recommendation to adjust the current bid amounts to the first bid amounts in response to determining the first average cost per action is equal to or within a predetermined amount under the current average cost per action. The operations further include adjusting the first marginal cost and repeating the estimating and calculating with the adjusted first marginal cost until the adjusted first marginal cost results in the first average cost per action being equal to or within the predetermined amount under the current average cost per action in response to determining the first average cost per action is above the current average cost per action or under the current average cost per action by more than the predetermined amount.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is a block diagram of an analysis system and associated environment according to an illustrative implementation.

FIG. 2 is a flow diagram of a process for determining an adjustment to a bidding strategy of a content provider according to an illustrative implementation.

FIG. 3 is a flow diagram of a process for determining an adjustment to a bidding strategy of a content provider by estimating a value of an additional action performed in association with a content item according to an illustrative implementation.

FIG. 4 is a flow diagram of a process for determining an adjustment to a bidding strategy of a content provider by estimating a value of an additional action performed in association with a content item according to another illustrative implementation.

FIG. 5 is a block diagram of a detailed implementation of an analysis system according to an illustrative implementation.

FIG. 6 is an illustration of a user interface configured to provide recommendations for bidding strategy changes to a content provider according to an illustrative implementation.

FIG. 7 is a block diagram of a computing system according to an illustrative implementation.

### DETAILED DESCRIPTION

Referring generally to the figures, various illustrative systems and methods are provided for identifying improved bidding strategies for content providers in online auctions. More particularly, the systems and methods herein may determine when a content provider is bidding in a manner such that bid adjustments may result in lower costs and/or increased benefit to the content provider. Recommendations for adjusting a bidding strategy may then be provided to the content provider.

First-party content for display on a resource can include text, video, and/or audio information provided by the first-party content providers via, for example, a resource server for presentation on a client device over the Internet. The first-party content may be a webpage requested by the client device or a stand-alone application (e.g., a video game, a chat program, etc.) running on the client device. Third-party content may be a public service announcement or advertisement that appears in conjunction with a requested resource, such as a webpage (e.g., a search result webpage from a search engine, a webpage that includes an online article, a webpage of a social networking service, etc.) or with an application (e.g., an advertisement within a game). A person viewing a resource can access the first-party content that is the subject of the resource as well as the third-party content that may or may not be related to the subject matter of the resource.

An online auction conducted by a content management system may select third-party content to be displayed on a user device. A plurality of content providers (e.g., advertisers) may participate in the online auctions. Bidding effectively in an online auction for providing content items for display on a resource may be relatively complex. A content provider may need to specify different bidding strategies on different types of auctions (e.g., auctions for queries on mobile devices and desktop devices, auctions on different keywords, auctions on different locations or demographics, or auctions on different networks such as a display content network, search-based content network, etc.). Further, the content provider may use a bidding strategy that includes bidding a lesser amount than a true value of winning a particular auction, and the amount by which a content provider shades their bid from the true value may depend on the competing bids of other content providers. Due to the complexity of bid optimization, it can be extremely challenging for the content provider to bid in the most effective way across all types of auctions.

In one implementation, an optimal or desired bidding strategy may include having content providers bid in such a way that their marginal cost for an additional click (or other interaction with their content item) equals their value for the click (or other interaction). The marginal cost per click is an additional cost to the content provider to obtain an additional click or interaction with the content item from bidding in the auction. The content provider may generally wish to bid in such a way that the value of the click or interaction equals the marginal cost per click. This is because if the value is less than the marginal cost, the content provider could then obtain greater profits by bidding more and obtaining more clicks and conversions at less than the cost that the clicks and conversions are worth to the content providers. The systems and methods described herein improve a bidding strategy of the content provider in such a way.

In one implementation, the systems and methods herein detect when a content provider is using a bidding strategy that can be adjusted to result in increased benefits and/or decreased costs to the content provider. For example, a content provider may bid in such a way that their marginal cost in one type of auction is dramatically lower than their marginal cost in another type of auction. A bidding strategy of the content provider may be improved upon if the marginal costs differ greatly, for example, based on an assumption that the marginal value of increased clicks/conversions/etc. is approximately equal between the types of auctions. The analysis system described herein may detect when the marginal costs differ greatly and recommend a change in the bidding strategy to increase benefits for the content provider.

The analysis system may recommend the changes without knowing how much the content provider values a click (or other interaction) associated with their content item. In one implementation, the analysis system may estimate how much the content provider values a particular interaction based on previous bidding history of the content provider. The analysis system may select a most appropriate example from the bidding history based on how frequently the content provider has participated in a particular auction, if there are any outlier bids in the bidding history compared to bids for a particular auction, etc. In another implementation, the analysis system may estimate how much the content provider values a particular interaction by calculating an average cost per action for the content provider across all auctions the content provider is participating in. The analysis system may use the average cost per action to determine an improved bidding strategy in a particular auction. Such an implementation may keep the total amount the content provider is spending the same, while decreasing the content provider's cost per conversion (thereby increasing the number of conversions of the content provider's content items without increasing cost).

By generating recommendations for bidding strategy changes, the systems and methods herein may identify opportunities for the content management system to suggest benefits to content providers, allowing the content providers to obtain more value out of interactions with the content management system. In one implementation, the systems and methods herein may generate an interface to provide the suggestions to the content providers.

For situations in which the systems discussed herein collect and/or utilize information pertaining to one or more particular content providers, steps may be taken to prevent individualized data for particular content providers from being discoverable or reverse-engineered. In some implementations, the information may be anonymized in one or more ways before it is utilized, such that the identity of the content provider with which it is associated cannot be discerned from the anonymized information. Additionally, data from multiple content providers may be aggregated, and data presented to a content provider may be based on the aggregated data, rather than on individualized data. In some implementations, the system may include one or more filtering conditions to ensure that the aggregated data includes enough data samples from enough content providers to prevent against any individualized content provider data being obtained from the aggregated data. The system does not present individualized data for a content provider to any other content provider.

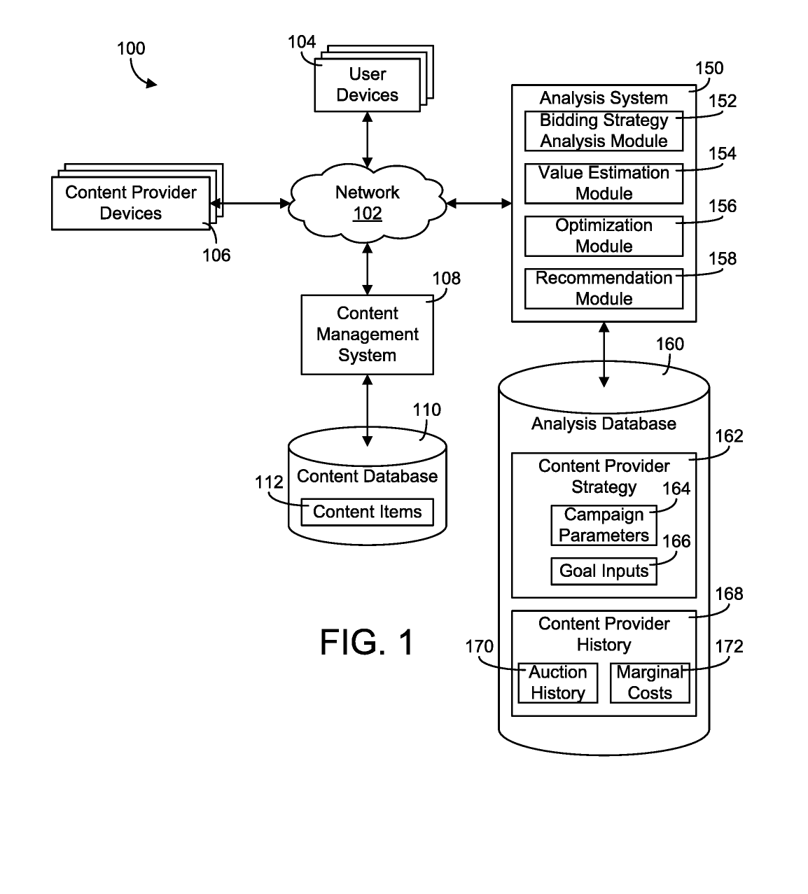

Referring now to FIG. 1, and in brief overview, a block diagram of an analysis system 150 and associated environment 100 is shown according to an illustrative implementation. One or more user devices 104 may be used by a user to perform various actions and/or access various types of content, some of which may be provided over a network 102 (e.g., the Internet, LAN, WAN, etc.). For example, user devices 104 may be used to access websites (e.g., using an Internet browser), media files, and/or any other types of content. A content management system 108 may be configured to select content for display to users within resources (e.g., webpages, applications, etc.) and to provide content items 112 from a content database 110 to user devices 104 over network 102 for display within the resources. The content items from which content management system 108 selects may be provided by one or more content providers via network 102 using one or more content provider devices 106.

In some implementations, bids for content to be selected by content management system 108 may be provided to content management system 108 from content providers participating in an auction using devices, such as content provider devices 106, configured to communicate with content management system 108 through network 102. In such implementations, content management system 108 may determine content to be published in one or more content interfaces of resources (e.g., webpages, applications, etc.) shown on user devices 104 based at least in part on the bids.

An analysis system 150 may be configured to analyze bidding strategies employed by the content providers. Analysis system 150 may generally be configured to determine if the bidding strategy being used by the content provider can be improved, and to recommend a new bidding strategy to the content provider. In some implementations, analysis system 150 may receive campaign parameters 164, goal inputs 166, and other information relating to the bidding strategy of the content provider. The information may be provided from content provider devices 106 and/or stored in an analysis database 160. Analysis system 150 may further use bidding history 168 of the content provider to estimate how much the content provider values an interaction with a particular content item.

Referring still to FIG. 1, and in greater detail, user devices 104 and/or content provider devices 106 may be any type of computing device (e.g., having a processor and memory or other type of computer-readable storage medium), such as a television and/or set-top box, mobile communication device (e.g., cellular telephone, smartphone, etc.), computer and/or media device (desktop computer, laptop or notebook computer, netbook computer, tablet device, gaming system, etc.), or any other type of computing device. In some implementations, one or more user devices 104 may be set-top boxes or other devices for use with a television set. In some implementations, content may be provided via a web-based application and/or an application resident on a user device 104. In some implementations, user devices 104 and/or content provider devices 106 may be designed to use various types of software and/or operating systems. In various illustrative implementations, user devices 104 and/or content provider devices 106 may be equipped with and/or associated with one or more user input devices (e.g., keyboard, mouse, remote control, touchscreen, etc.) and/or one or more display devices (e.g., television, monitor, CRT, plasma, LCD, LED, touchscreen, etc.).

User devices 104 and/or content provider devices 106 may be configured to receive data from various sources using a network 102. In some implementations, network 102 may include a computing network (e.g., LAN, WAN, Internet, etc.) to which user devices 104 and/or content provider device 106 may be connected via any type of network connection (e.g., wired, such as Ethernet, phone line, power line, etc., or wireless, such as WiFi, WiMAX, 3G, 4G, satellite, etc.). In some implementations, network 102 may include a media distribution network, such as cable (e.g., coaxial metal cable), satellite, fiber optic, etc., configured to distribute media programming and/or data content.

Content management system 108 may be configured to conduct a content auction among third-party content providers to determine which third-party content is to be provided to a user device 104. For example, content management system 108 may conduct a real-time content auction in response to a user device 104 requesting first-party content from a content source (e.g., a website, search engine provider, etc.) or executing a first-party application. Content management system 108 may use any number of factors to determine the winner of the auction. For example, the winner of a content auction may be based in part on the third-party content provider's bid and/or a quality score for the third-party provider's content (e.g., a measure of how likely the user of the user device 104 is to click on the content). In other words, the highest bidder is not necessarily the winner of a content auction conducted by content management system 108, in some implementations.

Content management system 108 may be configured to allow third-party content providers to create campaigns to control how and when the provider participates in content auctions. A campaign may include any number of bid-related parameters, such as a minimum bid amount, a maximum bid amount, a target bid amount, or one or more budget amounts (e.g., a daily budget, a weekly budget, a total budget, etc.). In some cases, a bid amount may correspond to the amount the third-party provider is willing to pay in exchange for their content being presented at user devices 104. In some implementations, the bid amount may be on a cost per impression or cost per thousand impressions (CPM) basis. In further implementations, a bid amount may correspond to a specified action being performed in response to the third-party content being presented at a user device 104. For example, a bid amount may be a monetary amount that the third-party content provider is willing to pay, should their content be clicked on at the client device, thereby redirecting the client device to the provider's webpage or another resource associated with the content provider. In other words, a bid amount may be a cost per click (CPC) bid amount. In another example, the bid amount may correspond to an action being performed on the third-party provider's website, such as the user of the user device 104 making a purchase. Such bids are typically referred to as being on a cost per acquisition (CPA) or cost per conversion basis.

A campaign created via content management system 108 may also include selection parameters that control when a bid is placed on behalf of a third-party content provider in a content auction. If the third-party content is to be presented in conjunction with search results from a search engine, for example, the selection parameters may include one or more sets of search keywords. For instance, the third-party content provider may only participate in content auctions in which a search query for “golf resorts in California” is sent to a search engine. Other illustrative parameters that control when a bid is placed on behalf of a third-party content provider may include, but are not limited to, a topic identified using a device identifier's history data (e.g., based on webpages visited by the device identifier), the topic of a webpage or other first-party content with which the third-party content is to be presented, a geographic location of the client device that will be presenting the content, or a geographic location specified as part of a search query. In some cases, a selection parameter may designate a specific webpage, website, or group of websites with which the third-party content is to be presented. For example, an advertiser selling golf equipment may specify that they wish to place an advertisement on the sports page of a particular online newspaper.

Analysis system 150 may analyze data from analysis database 160, content provider devices 106, and various other sources via network 102 to determine if a bidding strategy used by a content provider can be improved, and to provide recommendations for adjusting the bidding strategy if the bidding strategy can be improved. Analysis system 150 may include one or more processors (e.g., any general purpose or special purpose processor), and may include and/or be operably coupled to one or more memories (e.g., any computer-readable storage media, such as a magnetic storage, optical storage, flash storage, RAM, etc.). In various implementations, analysis system 150 and content management system 108 may be implemented as separate systems or integrated within a single system (e.g., content management system 108 may be configured to incorporate some or all of the functions/capabilities of analysis system 150).

Analysis system 150 may include one or more modules (e.g., implemented as computer-readable instructions executable by a processor) configured to perform various functions. Analysis system 150 is shown to include a bidding strategy analysis module 152. Bidding strategy analysis module 152 may analyze a bidding strategy of a content provider and determine if the bidding strategy can be improved. In one implementation, bidding strategy analysis module 152 is configured to retrieve information relating to content provider activity in multiple types of auctions. Bidding strategy analysis module 152 may retrieve the information from analysis database 160 (e.g., retrieving content provider history 168), content database 110 (e.g., from log files associated with auctions), content provider devices 106, and/or from other sources.

In one implementation, bidding strategy analysis module 152 determines or retrieves a marginal cost for each type of auction the content provider is participating in. The marginal cost represents a cost to a content provider associated with an additional action performed in association with a content item of the content provider, presented within one or resources. In other words, when a content item is to presented for display on a resource, the marginal cost represents a cost for gaining an additional user interaction with the content item. In one implementation, the marginal cost is a cost per click that represents a cost to the content provider for gaining an additional click on the content item. In other implementations, the marginal cost may represent other possible interactions with the content item (e.g., a cost per conversion, a cost per impression, etc.).

Bidding strategy analysis module 152 may determine a marginal cost for each type of auction for which the content provider is participating. If the marginal costs for different auctions differ significantly (e.g., if the difference is above a threshold), bidding strategy analysis module 152 may determine that the bidding strategy of the content provider can be improved. Since the marginal costs differ significantly, the marginal cost in one (or more) of the types of auctions may be lower than desired because the content provider is paying more for presenting content items in some auctions compared to other auctions.

Bidding strategy analysis module 152 may determine marginal costs for various types of auctions. For example, auctions may be separated based on which device platform (e.g., laptop, tablet, desktop, etc.) the auctions are affiliated with. As another example, auctions may be separated based on different keywords (e.g., for an auction related to a keyword search, each different term or groups of terms may have its own auction). In yet another example, auctions may be separated based on a type of content platform (e.g., video, image, search-based, etc.). Bidding strategy analysis module 152 may determine marginal costs for any particular auction or group of auctions, and may group auctions based on any characteristic of the auctions.

Analysis system 150 is shown to include a value estimation module 154. Value estimation module 154 may determine how a content provider values a particular interaction with a content item. If the content provider bidding strategy can be improved (identified by bidding strategy analysis module 152), analysis system 150 is configured to generate recommendations to the content provider for adjusting the bidding strategy. However, analysis system 150 may not know how a content provider values a particular interaction with a content item. The interaction may be a click, view, conversion, or other type of action that represents a user interacting with a content item on a resource. Value estimation module 154 may use information relating to the content provider to estimate the value of an interaction.

In one implementation, value estimation module 154 is configured to use the marginal cost for different types of auctions the content provider is participating in (determined by bidding strategy analysis module 152) and content provider history 168 to determine the value of an interaction to the content provider. Since the marginal cost for different types of auctions differ, it may not be clear which of the marginal costs most accurately reflects how much the content provider values an interaction. Value estimation module 154 may use content provider history 168 to determine which of the auctions, and therefore which of the marginal costs, are most reflective of the content provider's value. For example, value estimation module 154 may use auction history 170 to determine which types of auctions the content provider most frequently participates in, and use the marginal costs from such auctions to determine the value of an interaction to the content provider. As another example, auction history 170 may include which types of auctions the content provider has participated in for the longest time, which may indicate which types of auctions are most important to the content provider and therefore which marginal costs most reflect the content provider's value of an interaction. As yet another example, auction history 170 may include how much a content provider has spent on each type of auction, which may indicate to value estimation module 154 which type of auction is most relevant to the content provider. Value estimation module 154 may retrieve marginal costs 172 from analysis database 160, or determine marginal costs via other sources, of the most relevant auction or auctions as determined from auction history 170.

In one implementation, value estimation module 154 may retrieve a marginal cost from a single auction to use to determine the value of an interaction to the content provider. In another implementation, value estimation module 154 may determine a set of auctions, and use an average of a marginal cost across the set of auctions to determine the value of an interaction to the content provider. In yet another implementation, value estimation module 154 may determine a set of auctions, and use a weighted average (with auctions more relevant to the interests of the content provider being weighted more heavily) of marginal costs across the set of auctions to determine the value of an interaction to the content provider.

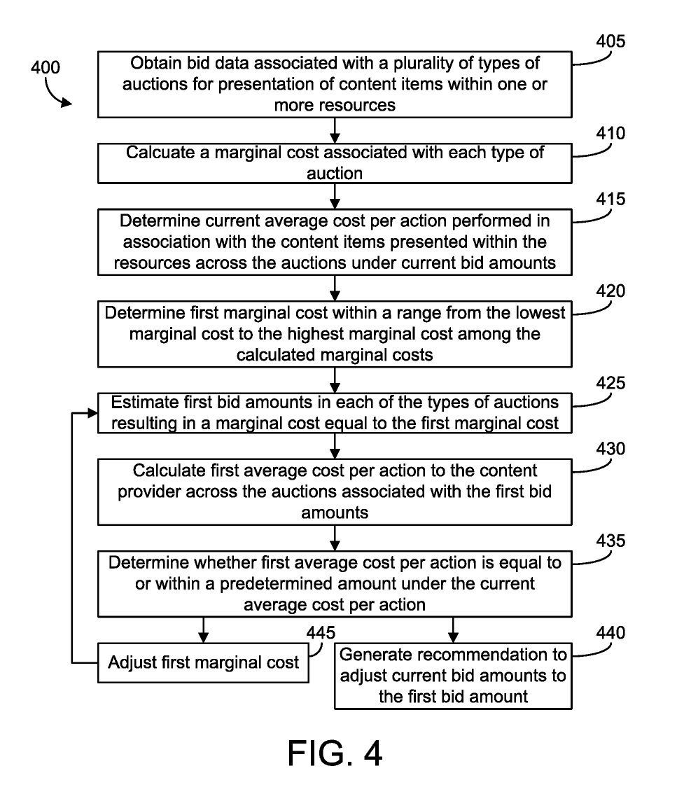

In one implementation, value estimation module 154 may calculate an estimated value of an interaction based on an average cost per click of the content provider across all auctions the content provider is participating in. In determining or retrieving a marginal cost to use for estimating the value of an interaction, value estimation module 154 may use the average cost per click (or other average cost per conversion, impression, etc.) to estimate the value of the interaction. In some embodiments, value estimation module 154 determines the estimated value of the interaction by calculating an amount the content provider would have to bid in each different type of auction such that the content provider's marginal cost in each auction would be equal to the highest marginal cost that the content provider currently faces in any of the auctions. This amount is compared to an average marginal cost that the advertiser is currently facing across all auctions. If the average cost is less than the calculated amount based on the highest marginal cost, then an alternative bidding strategy is able to provide the content provider with more clicks, conversions, and profits than the current bidding strategy. Value estimation module 154 may then recursively calculate the new bidding strategy by adjusting the value of the highest marginal cost. Such an algorithm is described in greater detail, according to one illustrative implementation, in FIG. 4.

Analysis system 150 is shown to include an optimization module 156. Optimization module 156 may suggest an adjustment to a current bidding strategy of the content provider. The adjustment may be generated based on the estimated value of an interaction determined by value estimation module 154. Optimization module 156 may determine bidding strategy adjustments for a bidding strategy while considering one or more characteristics or goals identified or provided by the content provider. For example, such characteristics or goals may include increasing profits or increasing conversions or interactions with content items. As another example, such characteristics or goals may include one or more constraints, such as not spending more than a certain budget or ensuring that a cost per conversion or click is less than a specific amount. Optimization module 156 may receive the parameters from content provider devices 106, or may retrieve the parameters from analysis database 160. Analysis database 160 is shown to include a content provider strategy 162, which may include campaign parameters 164 and goal inputs 166. Campaign parameters 164 may include a budget for a content provider campaign, start and end dates, a schedule, content items to be presented on resources during the campaign, bids, selection criteria, platforms or resources to present the content items on, and other such information. Goal inputs 166 may include various goals that the content provider has for a campaign, such as increasing profit, increasing a number of conversions, clicks, or other interactions with content items, increasing an awareness of the content provider or a product or service of the content provider, or increasing profit under one or more constraints (e.g., a budget amount, making a positive profit, making at least a minimum profit, or making a minimum return on investment). Optimization module 156 may determine adjustments to bidding strategies of the content providers subject to content provider strategy 162 and the estimated value of an interaction to the content provider.

Analysis system 150 is shown to include a recommendation module 158. Recommendation module 158 is configured to generate a recommendation to the content provider based on the suggested bidding strategy adjustments by optimization module 156. In one implementation, recommendation module 158 may generate an interface for display on a content provider device 106 providing the recommendations.

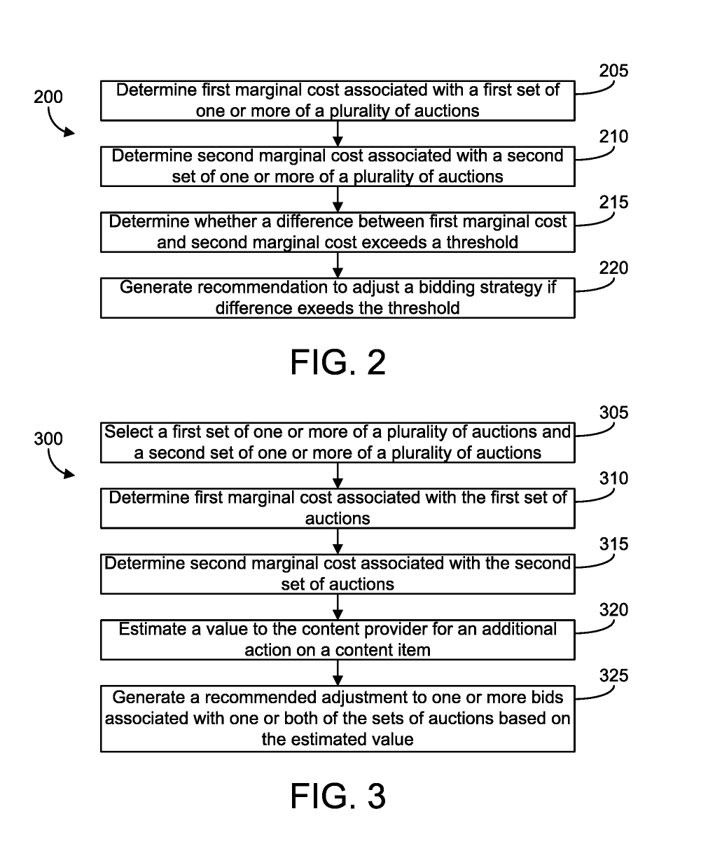

FIG. 2 illustrates a flow diagram of a process 200 for determining an adjustment to a bidding strategy of a content provider according to an illustrative implementation. Process 200 may be executed by, for instance, analysis system 150 as described with reference to FIG. 1.

Referring now to both FIGS. 1 and 2, process 200 includes determining a first marginal cost associated with a first set of one or more of a plurality of auctions (block 205). The auctions are provided to the content provider for presentation of content items within one or more resources. The marginal cost represents a cost to a content provider associated with an additional action performed in association with the content items presented within the resource. In other words, when a content item is to be presented for display on a resource, the marginal cost represents a cost for gaining an additional user interaction with the content item. In one implementation, the marginal cost is a marginal cost per click associated with obtaining an additional selection of a content item presented within a resource. In another implementation, the marginal cost is a marginal cost per conversion associated with obtaining an additional conversion (e.g., purchase of an item, download of an application, provision of requested information, etc.) in association with presentation of a content item within a resource.

Process 200 further includes determining a second marginal cost associated with a second set of one or more of the plurality of auctions (block 210). In various implementations, the first set and second set of auctions may include a single auction or a group of similar auctions. For example, the first set of auctions may be auctions for presenting content items on mobile devices, and the second set of auctions may be auctions for presenting content items on tablet devices. As another example, the first set of auctions may be auctions related to a first keyword and the second set of auctions may be auctions related to a second keyword.

Process 200 further includes comparing the first marginal cost and second marginal cost. Process 200 further includes determining whether a difference between the first marginal cost and second marginal cost exceeds a threshold (block 215). If the difference exceeds the threshold, a recommendation is generated to adjust a bidding strategy (block 220). In one implementation, the recommended adjustment is based on the first marginal cost and second marginal cost. For example, the recommendation may result in one of the first marginal cost and second marginal cost being decreased such that the first marginal cost and second marginal cost approximately equal one another.

In one implementation, the first set of auctions and second set of auctions are part of a plurality of sets of auctions. Process 200 may include determining marginal costs associated with each of the auctions. Analysis system 150 may calculate the variation amongst the marginal costs, and compare the variation to a threshold variation value. If the variation exceeds the threshold variation, a recommendation to adjust a bidding strategy is generated. For example, analysis system 150 may calculate an average marginal cost across the auctions, and if the difference between the average and any of the marginal costs exceeds the threshold, a bid adjustment is recommended for the bids associated with the marginal costs exceeding the threshold. As another example, analysis system 150 may calculate an average marginal cost across the auctions, and if two or more of the marginal costs differ from the average by more than a threshold, a bid adjustment is recommended for the associated bids. In other words, analysis system 150 may execute process 200 for any number of auctions, and for any subset of auctions the content provider is participating in.

The recommendation to adjust the bidding strategy is based on the difference between the first marginal cost and second marginal cost, and may not consider the value of an additional action (e.g., a conversion, click, view, etc.) to the content provider. For example, process 200 may use the first marginal cost and second marginal cost to represent the value of an additional action to the content provider.

FIG. 3 illustrates a flow diagram of a process 300 for determining an adjustment to a bidding strategy of a content provider by estimating a value of an additional action performed in association with a content item according to an illustrative implementation. Process 300 may be executed by, for instance, analysis system 150 as described with reference to FIG. 1.

Referring now to both FIGS. 1 and 3, process 300 includes selecting a first set of one or more of a plurality of auctions and a second set of one or more of a plurality of auctions (block 305). Analysis system 150 may select the first set of auctions and second set of auctions from a plurality of auctions the content provider is participating in. The marginal costs associated with the auctions that are selected are used to determine the value of an additional action performed in association with a content item to be presented on a resource via the auction.

In one implementation, the first set of auctions and second set of auctions are selected based on an amount of time in which the content provider has been bidding in the auctions. For example, analysis system 150 may select auctions that the content provider has been participating in for the longest time, since the auction results may be most representative of how the content provider values an interaction with a content item.

In one implementation, the first set of auctions and second set of auctions are selected based on an amount of budget expended by the content provider in the auctions. For example, analysis system 150 may select auctions in which the content provider is spending the most, since the auction results may be most representative of how the content provider values an interaction with a content item.

The first set of auctions and second set of auctions may be selected based on other factors. For example, the first set of auctions may be related to a first platform (e.g., a desktop platform) while the second set of auctions may be related to a second platform (e.g., a mobile platform).

Process 300 includes determining a first marginal cost associated with the first set of auctions (block 310) and a second marginal cost associated with the second set of auctions (block 315). The activities of blocks 310, 315 may be similar to those of blocks 205, 210 of FIG. 2.

Process 300 includes estimating a value to the content provider for an additional action on a content item (block 320), based on at least one of the first marginal cost and the second marginal cost. In one implementation, the first marginal cost and second marginal cost are marginal costs per click associated with obtaining an additional selection of a content item presented within a resource. The estimated value is the estimated value to the content provider of the additional selection. In another implementation, the first marginal cost and second marginal cost are marginal costs per conversion associated with obtaining an additional conversion in association with presentation of a content item within a resource. The estimated value is an estimated value to the content provider of the additional conversion.

In one implementation, estimating the value includes determining that the value of an additional action to the content provider is equal to one of the first marginal cost and second marginal cost. For example, at block 320, analysis system 150 may determine that the lowest marginal cost is the estimated value of an additional action to the content provider. In another implementation, estimating the value includes averaging the first marginal cost and the second marginal cost and using the average marginal cost as the estimated value. In yet another implementation, estimating the value includes applying a first weight to the first marginal cost and a second weight to the second marginal cost. A weighted average of the first marginal cost and second marginal cost is then computed and used as the estimated value. In yet another implementation, estimating the value includes combining the first marginal cost and second marginal cost in any other mathematical way and using the combination of the marginal costs as the estimated value.

Process 300 includes generating a recommended adjustment to one or more bids associated with one or both of the sets of auctions based on the estimated value (block 325). In one implementation, the recommendations may cause increased profits for the content provider as compared to profits obtained under the current values of the bids. For example, analysis system 150 may adjust the bids to increase marginal costs to equal the estimated value. In one implementation, the recommendations may cause increased actions performed in association with the content items presented in a resource as compared to actions obtained under current values of the bids. For example, analysis system 150 may adjust the bids such that the content provider may obtain more interactions with the content items for the same cost. In one implementation, the recommendations may cause a total cost under the adjusted bids to not increase beyond a budget amount of the content provider. The recommendations are provided to increase value to the content provider without increasing the budget of the content provider. In one implementation, the recommendations may cause an average cost per action under the adjusted bids not to increase beyond a specified average cost amount. For example, the recommendations may increase interactions with a content item without increasing the average marginal cost.

FIG. 4 illustrates a flow diagram of a process 400 for determining an adjustment to a bidding strategy of a content provider by estimating a value of an additional action performed in association with a content item according to another illustrative implementation. Process 400 may be executed by, for instance, analysis system 150 as described with reference to FIG. 1.

Referring now to both FIGS. 1 and 4, process 400 includes obtaining bid data associated with a plurality of types of auctions for presentation of content items within one or more resources (block 405). Analysis system 150 may retrieve the bid data from a content provider device, an analysis database configured to store bid history of content providers, or otherwise. Analysis system 150 may obtain bid data for all types of auctions the content provider is participating in (e.g., auctions for queries on both mobile devices and desktop devices).

Process 400 includes calculating a marginal cost associated with each type of auction (block 410). The marginal cost represents a cost to a content provider associated with an additional action performed in association with the content items presented within the resource. In other words, when a content item is to be presented for display on a resource, the marginal cost represents a cost for gaining an additional user interaction with the content item.

Process 400 includes determining a current average cost per action performed in association with the content items presented within the resources across the auctions under current bid amounts (block 415). The average cost per action is the average cost that the content provider currently pays to achieve a certain number of actions.

Process 400 includes determining a highest marginal cost and lowest marginal cost across all the auctions that the content provider is participating in. In one implementation, the lowest marginal cost is set to zero. Process 400 includes determining a first marginal cost within a range from the lowest marginal cost to the highest marginal cost among the calculated marginal costs (block 420). In one implementation, block 420 includes setting the first marginal cost equal to the highest marginal cost (e.g., the marginal cost for which the content provider is receiving the best return).

Process 400 includes estimating first bid amounts in each of the types of auctions resulting in a marginal cost equal to the first marginal cost (block 425). For example, if the first marginal cost is set to the highest marginal cost, analysis system 150 may estimate first bid amounts such that the content provider's marginal cost in auctions using the bid amounts would equal the highest marginal cost.

Process 400 includes calculating a first average cost per action to the content provider across the auctions associated with the first bid amounts (block 430). In other words, if the content provider were to follow the first bid amounts across all auctions, the average cost per action to the content provider is determined. Process 400 includes determining whether the first average cost per action is equal to or within a predetermined amount (e.g., 1%) under the current average cost per action (block 435). If the first average cost per action is less than the current average (calculated at block 415), then using the bidding strategy with the estimated first bid amount gives the content provider greater clicks, conversions, and profits than the current bidding strategy at a lower average cost per click. Therefore, a more successful alternative bidding strategy is identified. When the first average cost per action is equal to or within a predetermined amount under the current average cost per action, a recommendation is generated to adjust current bid amounts to the first bid amount (block 440).

If the first average cost per action is not equal to or within a predetermined amount under the current average cost per action, process 400 includes adjusting the first marginal cost and repeating the estimating and calculating with the adjusted first marginal cost until the adjusted first marginal cost results in the first average cost per action being equal to or within a predetermined amount under the current average cost per action (block 445). In other words, blocks 425-435 are repeated with a new first marginal cost.

Analysis system 150 may apply process 400 recursively. For example, if the first average cost per action is not equal to or within a predetermined amount under the current average cost per action, then the first bid amounts are adjusted accordingly. The first marginal cost may be set to an average of the highest marginal cost and lowest marginal cost, and an average cost per action is recalculated at block 430. If this does not result in an average cost per action approximately equal to the current average cost per action, analysis system 150 may apply process 400 recursively again. If the average cost per action is greater than the current average cost per action, the value of the highest marginal cost may be set to the average marginal cost. If the average cost per action is less than the current average cost per action, the value of the lowest marginal cost may be set to the average marginal cost. In other words, the possible range of values which contain the ideal average cost per action is halved during each iteration of the process. Recursively applying the process eventually results in meeting the desired condition of the average cost per action equaling the current average cost per action.

In one implementation, bid curves and cost curves may be generated based on the obtained bid data. The bid curves and cost curves may be used in the steps of calculating the marginal cost associated with each type of auction, determining the current average cost per action, estimating the first bid amounts, and calculating the first average cost per action performed. A bid curve or cost curve may include bids and incremental costs across previously completed auctions that the content provider has participated in. A bid curve or cost curve may also represent the total cost that the content provider would pay for any given bid. A bid curve may further represent the total amount a content provider would need to bid in order to achieve a certain number of interactions (e.g. clicks or conversions). A cost curve may further represent the total amount a content provider would need to pay in order to achieve a certain number of interactions (e.g. clicks or conversions).

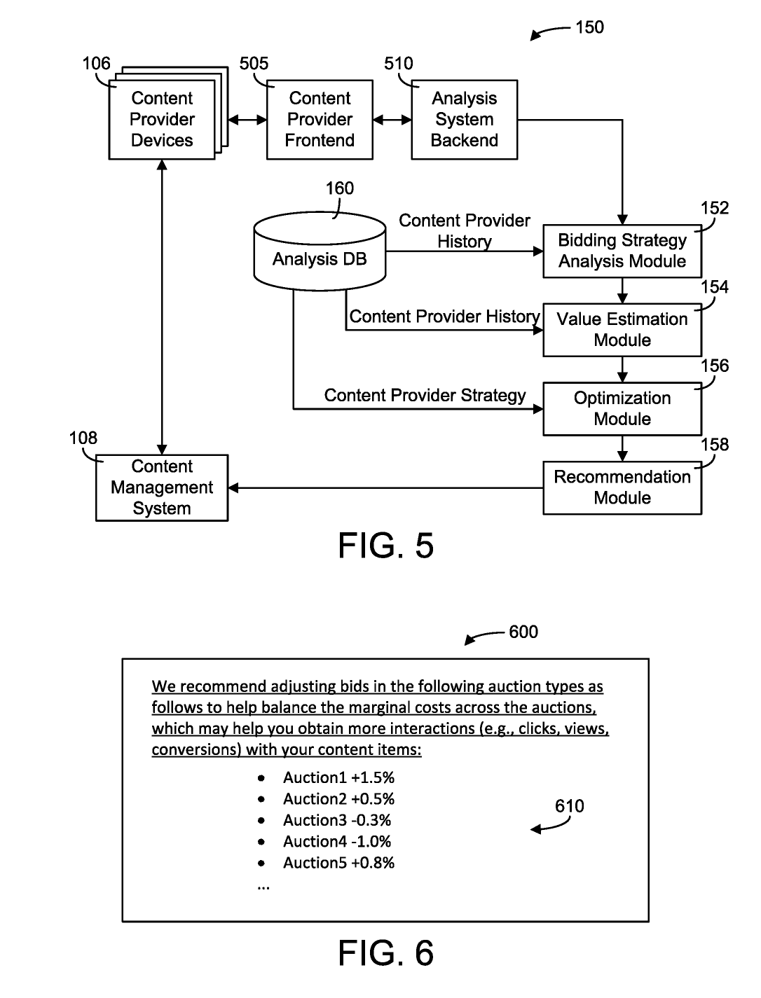

Referring now to FIG. 5, one detailed illustrative implementation of analysis system 150 is provided. In the illustrated implementation, analysis system 150 includes a content provider frontend 505, an analysis system backend 510, and a plurality of modules 152-158 as described in FIG. 1 to execute the systems and methods described herein. It should be understood that the detailed implementation of analysis system 150 shown in FIG. 5 is provided for purposes of illustration, and in other implementations, analysis system 150 may include additional, fewer, and/or different components. Further, each of the illustrated systems and/or components may be implemented as a separate computing system, multiple systems may be combined within a single hardware system, and/or one or more systems or components may be implemented in a cloud, or distributed computing, environment.

Content provider devices 106 may provide information to and/or receive information from analysis system 150 via a content provider frontend 505. Content provider frontend 505 may provide an interface through which content providers can provide data, modify settings or parameters used by analysis system 150, receive information from analysis system 150, etc. In some implementations, content provider frontend 505 may be or include a web-based user interface (e.g., implemented via a web-based programming language such as HTML, Javascript®, etc.). In some implementations, content provider frontend 505 may include a custom API specific to a particular content provider. In some implementations, content provider frontend 505 may allow content providers to upload data sets individually and/or in batches. While the implementation shown in FIG. 5 illustrates content provider devices 106 and frontend 505, other components of system 100 may connect with analysis system 150 in a similar manner.

Content provider frontend 505 may transmit data to and receive data from an analysis system backend 510. Analysis system backend 510 may be configured to retrieve data and/or generate commands needed to perform various functions of analysis system 150. In some implementations, analysis system backend 510 may implement the various functions by transmitting commands to various modules configured to carry out particular functions or sets of functions. For instance, analysis system backend 510 may collect data relating to a plurality of content items received from content provider devices 106, content management system 108, or another source. Analysis system backend 510 may transmit content provider strategies or content provider bidding history to modules 152-158. The data transmitted may be any type of data related to content provider interaction with content management system 108, and may be provided in any type of format. For instance, the data may be structured as a lookup table, linked lists, in trees, or as any other type of data structure (e.g., records, lists, arrays, queue, stack, etc.). The data may be any type of data relating to a goal or strategy of a campaign of the content provider, for example.

Bidding strategy analysis module 152 may receive content provider strategy information, content provider bidding history, and content provider auction history, and may determine if the bidding strategy of the content provider can be improved. In one implementation, the information may include the different types of auctions the content provider is participating in. For example, the content provider may be participating in n different types of auctions, each auction representing a different platform (e.g., mobile, desktop, etc.).

If the content provider bidding strategy can be improved, value estimation module 154 may determine how the content provider values a particular interaction with a content item. In one implementation, the content provider is presumed to value all conversions with a content item equally at a value v per conversion. Value estimation module 154 may use content provider history, such as an auction history of the content provider or marginal costs associated with a particular action with a content item of the content provider. The auction history may include how often a content provider has participated in a type of auction, the cost to the content provider for participating in the auctions, and the like.

Once an interaction with a content item is valued by value estimation module 154, optimization module 156 may determine a new bidding strategy based on the value. Optimization module 156 receives a content provider strategy from analysis database 160 to help determine the new bidding strategy. The content provider strategy may include information indicating how many conversions xᵢ the content provider wishes to obtain on a particular auction or platform. If the content provider wishes to obtain xᵢ on an individual auction or platform i, the content provider should spend an amount sᵢ(xᵢ), where sᵢ(xᵢ) is a strictly increasing and convex function of xᵢ. Optimization module 156 may use such information to calculate the new bidding strategy.

In one implementation, a detailed process similar to that of process 400 is described for optimization module 156 calculating the bid adjustment. The content provider may have various goals when participating in auctions. For example, the content provider may care only about maximizing a total payoff from having their content items displayed. The content provider would seek to maximize the difference between total value of displaying the content items and total cost, which can be represented as: Σᵢ₌₁ⁿvxᵢ−sᵢ(xᵢ). The function can be maximized by ensuring that v=sᵢ′(xᵢ), where sᵢ′(xᵢ) denotes the derivative of sᵢ(xᵢ) with respect to xᵢ or the marginal cost of an additional conversion on auction i. In other words, the content provider follows a bidding strategy such that the marginal cost for an additional conversion in an auction i is equal to the content provider's value for an additional conversion.

As another example, the content provider, in addition to wanting to maximize a total payoff, may also want to ensure that their average return on investment is sufficiently high. In other words, the content provider may wish to maximize their payoff, represented as Σᵢ₌₁ⁿvxᵢ−sᵢ(xᵢ), subject to the constraint that the average cost per conversion does not exceed some amount. This constraint may be represented as: Σᵢ₌₁ⁿsᵢ(xᵢ)/Σᵢ₌₁ⁿxᵢ≦c. c denotes an average cost per conversion that a content provider does not wish to exceed.

Such a goal is mathematically equivalent to maximizing Σᵢ₌₁ⁿvxᵢ−sᵢ(xᵢ) subject to the constraint that Σᵢ₌₁ⁿsᵢ(xᵢ)−c Σᵢ₌₁ⁿxᵢ≦0. By setting up a Lagrangian, values of xᵢ must be chosen in such a way to maximize Σᵢ₌₁ⁿvxᵢλ[Σᵢ₌₁ⁿsᵢ(xᵢ)−c Σᵢ₌₁ⁿxᵢ] for some value of λ. Differentiating with respect to xᵢ, a necessary condition for a set of values of xᵢ to be optimal is that v−s′ᵢ(xᵢ)−λ[s′ᵢ(xᵢ)−c]=0 or that (v−s′ᵢ(xᵢ))/(s′ᵢ(xᵢ)−c)=λ.

In other words, the value of (v−s′ᵢ(xᵢ))/(s′ᵢ(xᵢ)−c) should be the same for all i, meaning the value of the marginal cost sᵢ(xᵢ) should be the same on all auctions i. Thus, the possibility that content providers care about maintaining a certain average return on investment does not overturn the conclusion that a content provider's marginal cost for an additional conversion should be the same on all types of auctions if the content provider is bidding optimally.

Given this, if the current marginal cost per conversion for the content provider differs significantly on two different auctions, the content provider may achieve a greater total payoff without increasing the average cost per conversion, as described in processes 300 and 400. The new bidding strategy includes the same marginal cost per conversion across all auctions, but the overall average cost per conversion is maintained at c. Processes 300 and 400 described experimenting with a variety of possible marginal costs m and considering bidding strategies such that the content provider's marginal cost per conversion is equal to m across all auctions.

For large values of m, a content provider's average cost per conversion under such a strategy may exceed c. For small values of m, the content provider's average cost per conversion under such a strategy may be lower than c. For an intermediate value of m, a content provider who follows a strategy where the marginal cost per conversion is m on all auctions will have an average cost per conversion equal to c. This alternative strategy is recommended to the content provider as an improvement over the current strategy.

Recommendation module 158 may generate the recommendation of adjusting a bidding strategy based on the optimization of the bidding strategy at optimization module 156. In one implementation, recommendation module 158 and/or content management system 108 may generate an interface to present on a content provider device 106 to display the recommendation.

Referring now to FIG. 6, an example illustration of a user interface 600 is shown according to an illustrative implementation. User interface 600 may be presented on, for example, a content provider device 106. User interface 600 may provide recommendations to adjustments of a bidding strategy of a content provider. In various implementations, a content provider may request the recommendations from content management system 108 or may automatically be provided with the recommendations. Further, the interface may be formatted in various ways and is not limited to the webpage-like or mobile device screen-like format as shown in FIG. 6.

As described above, analysis system 150 may identify a bidding strategy that can be improved. User interface 600 may be presented to the content provider to identify bids of the bidding strategy that can be changed to improve the bidding strategy. In one implementation, user interface 600 may identify the particular auction types in which bids can be adjusted. User interface is shown to include a portion 610 which provides a list of types of auctions. Each auction may have their bids adjusted by a percentage up or down. In other implementations, the bid adjustment suggestion may be provided as a raw dollar value instead of a percentage. The user viewing user interface 600 may have an option to approve the bid adjustments, reject the bid adjustments, or accept or reject a subset of the bid adjustments, or to make additional changes to the bid adjustment values.

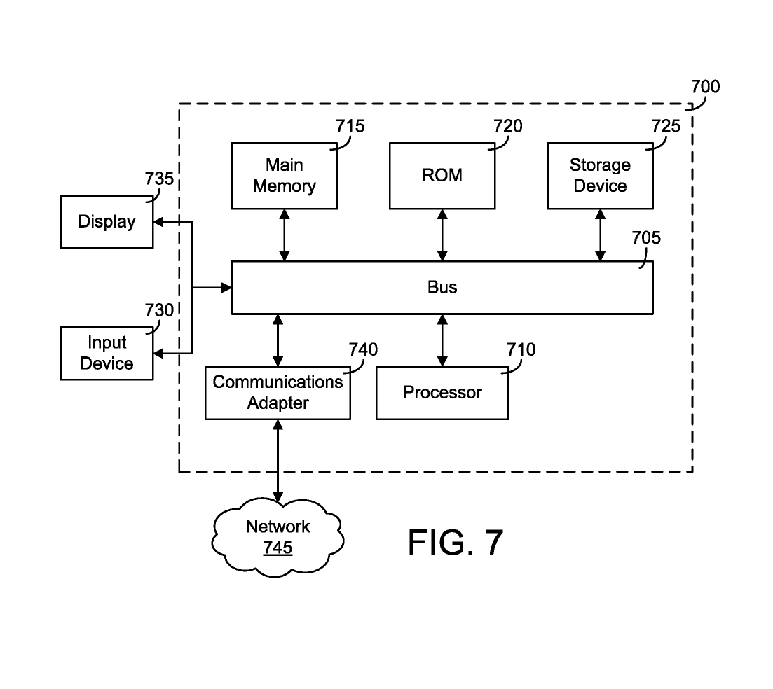

FIG. 7 illustrates a depiction of a computer system 700 that can be used, for example, to implement an illustrative user device 104, an illustrative content management system 108, an illustrative content provider device 106, an illustrative analysis system 150, and/or various other illustrative systems described in the present disclosure. Computing system 700 includes a bus 705 or other communication component for communicating information and a processor 710 coupled to bus 705 for processing information. Computing system 700 also includes main memory 715, such as a random access memory (RAM) or other dynamic storage device, coupled to bus 705 for storing information, and instructions to be executed by processor 710. Main memory 715 can also be used for storing position information, temporary variables, or other intermediate information during execution of instructions by processor 710. Computing system 700 may further include a read only memory (ROM) 710 or other static storage device coupled to bus 705 for storing static information and instructions for processor 710. A storage device 725, such as a solid state device, magnetic disk or optical disk, is coupled to bus 705 for persistently storing information and instructions.

Computing system 700 may be coupled via bus 705 to a display 735, such as a liquid crystal display, or active matrix display, for displaying information to a user. An input device 730, such as a keyboard including alphanumeric and other keys, may be coupled to bus 705 for communicating information, and command selections to processor 710. In another implementation, input device 730 has a touch screen display 735. Input device 730 can include a cursor control, such as a mouse, a trackball, or cursor direction keys, for communicating direction information and command selections to processor 710 and for controlling cursor movement on display 735.

In some implementations, computing system 700 may include a communications adapter 740, such as a networking adapter. Communications adapter 740 may be coupled to bus 705 and may be configured to enable communications with a computing or communications network 745 and/or other computing systems. In various illustrative implementations, any type of networking configuration may be achieved using communications adapter 740, such as wired (e.g., via Ethernet®), wireless (e.g., via WiFi®, Bluetooth®, etc.), pre-configured, ad-hoc, LAN, WAN, etc.

According to various implementations, the processes that effectuate illustrative implementations that are described herein can be achieved by computing system 700 in response to processor 710 executing an arrangement of instructions contained in main memory 715. Such instructions can be read into main memory 715 from another computer-readable medium, such as storage device 725. Execution of the arrangement of instructions contained in main memory 715 causes computing system 700 to perform the illustrative processes described herein. One or more processors in a multi-processing arrangement may also be employed to execute the instructions contained in main memory 715. In alternative implementations, hard-wired circuitry may be used in place of or in combination with software instructions to implement illustrative implementations. Thus, implementations are not limited to any specific combination of hardware circuitry and software.

Although an example processing system has been described in FIG. 7, implementations of the subject matter and the functional operations described in this specification can be carried out using other types of digital electronic circuitry, or in computer software, firmware, or hardware, including the structures disclosed in this specification and their structural equivalents, or in combinations of one or more of them.

Implementations of the subject matter and the operations described in this specification can be carried out using digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be implemented as operations performed by a data processing apparatus on data stored on one or more computer-readable storage devices or received from other sources.

The terms “data processing apparatus” or “computing device” encompass all kinds of apparatus, devices, and machines for processing data, including by way of example, a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be carried out using a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be carried out using a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

In some illustrative implementations, the features disclosed herein may be implemented on a smart television module (or connected television module, hybrid television module, etc.), which may include a processing circuit configured to integrate Internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be carried out in combination or in a single implementation. Conversely, various features that are described in the context of a single implementation can also be carried out in multiple implementations, separately, or in any suitable subcombination. Moreover, although features may be described above as acting in certain combinations and even initially claimed as such, one or more features from a claimed combination can, in some cases, be excised from the combination, and the claimed combination may be directed to a subcombination or variation of a subcombination. Additionally, features described with respect to particular headings may be utilized with respect to and/or in combination with illustrative implementations described under other headings; headings, where provided, are included solely for the purpose of readability and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method, comprising:
determining, by one or more processors, a first marginal cost associated with a first set of one or more of a plurality of auctions for presentation of content items within one or more resources, the marginal cost representing a cost to a content provider associated with an additional action performed in association with the content items presented within the resources;
determining, by the one or more processors, a second marginal cost associated with a second set of one or more of the plurality of auctions;
determining, by the one or more processors, whether a difference between the first marginal cost and the second marginal cost exceeds a threshold; and
generating a recommendation to adjust a bidding strategy in response to determining the difference exceeds the threshold.

2. The method of claim 1, wherein the first marginal cost and the second marginal cost comprise a marginal cost-per-click associated with obtaining an additional selection of a content item presented within the resources.

3. The method of claim 1, wherein the first marginal cost and the second marginal cost comprise a marginal cost-per-conversion associated with obtaining an additional conversion in association with presentation of a content item within the resources.

4. The method of claim 1, wherein the first set of auctions and the second set of auctions are part of a plurality of sets of one or more auctions, and wherein the method further comprises:
determining a marginal cost associated with each of the plurality of sets of auctions;
determining whether a variation amongst the marginal costs exceeds a threshold variation; and
generating the recommendation to adjust the bidding strategy in response to determining the variation amongst the marginal costs exceeds the threshold variation.

5. The method of claim 1, further comprising generating a recommended adjustment to the bidding strategy based on the first marginal cost and the second marginal cost.

6. The method of claim 1, the step of generating the recommendation to adjust the bidding strategy based on determining the difference between the first marginal cost and the second marginal cost exceeds the threshold without using a value to the content provider for the additional action.

7. A method comprising:
determining, by one or more processors, a first marginal cost associated with a first set of one or more of a plurality of auctions for presentation of content items within one or more resources, the marginal cost representing a cost to a content provider associated with an additional action performed in association with the content items presented within the resources;
determining, by the one or more processors, a second marginal cost associated with a second set of one or more of the plurality of auctions;
estimating, by the one or more processors, a value to the content provider for the additional action based on at least one of the first marginal cost and the second marginal cost; and
generating, by the one or more processors, a recommended adjustment to one or more bids associated with one or both of the first set of auctions or the second set of auctions based on the estimated value to the content provider.

8. The method of claim 7, further comprising selecting at least one of the first set of auctions or the second set of auctions from among the plurality of auctions for use in estimating the value to the content provider for the additional action based on an amount of time in which the content provider has been bidding in the at least one of the first set of auctions or the second set of auctions.

9. The method of claim 7, further comprising selecting at least one of the first set of auctions or the second set of auctions from among the plurality of auctions for use in estimating the value to the content provider for the additional action based on an amount of budget expended by the content provider in the at least one of the first set of auctions or the second set of auctions.

10. The method of claim 7, wherein the first marginal cost and the second marginal cost comprise a marginal cost-per-click associated with obtaining an additional selection of a content item presented within the resources, and wherein the estimated value comprises the estimated value to the content provider of the additional selection.

11. The method of claim 7, wherein the first marginal cost and the second marginal cost comprise a marginal cost-per-conversion associated with obtaining an additional conversion in association with presentation of a content item within the resources, and wherein the estimated value comprises the estimated value to the content provider of the additional conversion.

12. The method of claim 7, the step of estimating the value to the content provider of the additional action comprising estimating the value to be equal to the first marginal cost or the second marginal cost.

13. The method of claim 7, the step of estimating the value to the content provider of the additional action comprising estimating the value based on a combination of the first marginal cost and the second marginal cost.

14. The method of claim 13, the step of estimating the value to the content provider of the additional action comprising estimating the value based on an average of the first marginal cost and the second marginal cost.

15. The method of claim 14, the step of estimating the value to the content provider of the additional action comprising estimating the value based on a weighted average of the first marginal cost and the second marginal cost by applying a first weight to the first marginal cost and a second weight to the second marginal cost.

16. The method of claim 7, the step of generating the recommended adjustment to the one or more bids comprising generating the recommended adjustment estimated to cause one or more of the following:
increased profits for the content provider as compared to profits obtained under current values of the one or more bids;
increased actions performed in association with the content items presented within the resources as compared to actions obtained under current values of the one or more bids;
a total cost under the adjusted bids not greater than a budget amount; or
an average cost per action under the adjusted bids not greater than a specified average cost amount.

17. The method of claim 7, wherein the first set of auctions is associated with a first platform, and the second set of auctions is associated with a second platform.

18. The method of claim 7, wherein the first platform is a desktop platform, and the second platform is a mobile platform.

19. A method comprising:
obtaining, by one or more processors, bid data associated with a plurality of types of auctions for presentation of content items within one or more resources;
calculating, by the one or more processors, a marginal cost associated with each type of auction, the marginal cost representing a cost to a content provider associated with an additional action performed in association with the content items presented within the resources for the type of auction;
determining, by the one or more processors, a current average cost per action performed in association with the content items presented within the resources across the auctions under current bid amounts;
determining, by the one or more processors, a first marginal cost within a range from a lowest marginal cost to a highest marginal cost among the calculated marginal costs for the plurality of types of auctions;
estimating, by the one or more processors, first bid amounts in each of the types of auctions resulting in a marginal cost equal to the first marginal cost;
calculating, by the one or more processors, a first average cost per action to the content provider across the auctions associated with the first bid amounts;
determining, by the one or more processors, whether the first average cost per action is equal to or within a predetermined amount under the current average cost per action;
generating a recommendation to adjust the current bid amounts to the first bid amounts in response to determining the first average cost per action is equal to or within a predetermined amount under the current average cost per action;
adjusting the first marginal cost and repeating the estimating and calculating with the adjusted first marginal cost until the adjusted first marginal cost results in the first average cost per action equal to or within the predetermined amount under the current average cost per action in response to determining the first average cost per action is above the current average cost per action or under the current average cost per action by more than the predetermined amount.

20. The method of claim 19, the steps of calculating the marginal cost associated with each type of auction, determining the current average cost per action, estimating the first bid amounts, and calculating the first average cost per action performed using bid curves and cost curves generated based on the obtained bid data.
